(19) United States
(12) Patent Application Publication
(10) Pub. No.: US 2011/0253298 A1
(43) Pub. Date: Oct. 20, 2011

(54) METHOD FOR MANUFACTURING A PHOSPHOR FILM, METHOD FOR MANUFACTURING LIGHT EMITTING SUBSTRATE HAVING PHOSPHOR FILM, AND METHOD FOR MANUFACTURING DISPLAY BY THE METHOD

(75) Inventor: Haruo Tomono, Machida-shi (JP)

(73) Assignee: CANON KABUSHIKI KAISHA, Tokyo (JP)

(21) Appl. No.: 13/086,705

(22) Filed: Apr. 14, 2011

(30) Foreign Application Priority Data
Apr. 16, 2010 (JP) 2010-095093

(51) Int. Cl. B32B 37/14; B05D 5/06; B29C 43/28; B32B 37/02; B32B 38/00

(52) U.S. Cl. 156/242; 264/165; 427/71

(57) ABSTRACT

A method for manufacturing a phosphor film containing phosphor particles includes steps of bringing a pressing member into contact with a precursor layer containing phosphor particles and an organic resin, and heating the precursor layer to a temperature at which the organic resin is thermally decomposed or above while the precursor layer is in contact with the pressing member.

### BACKGROUND OF THE INVENTION

1. Field of the Invention

The present invention relates to a method for manufacturing a display having a phosphor film, in particular, to a method for manufacturing a light emitting substrate having a phosphor film that is used in flat panel displays such as plasma display panel (PDP) and field emission display (FED).

2. Description of the Related Art

PDPs and FEDs are known as flat panel displays that each have a light emitting substrate with a phosphor film. Japanese Patent Application Laid-Open No. 2002-216624 discusses a press molding method of a phosphor film that is prepared by coating phosphor paste containing phosphor particles, a binder, and a solvent, and drying and baking the coated phosphor paste. Japanese Patent Application Laid-Open No. 2002-216624 also discusses press molding of a dried phosphor paste before baking.

The method discussed in Japanese Patent Application Laid-Open No. 2002-216624, however, often causes unexpected projections on a surface of a phosphor film or undesired air gaps in the phosphor film because phosphor particles float due to decomposition gas generated from a binder during baking.

In the display, e.g., the FED, in which a phosphor film is irradiated with electron beams, a very thin conductive film referred to as a metal back is often provided on the phosphor film which requires the phosphor film to have a smooth surface profile. Any damage to the smoothness of a phosphor film may result in unintended holes or projections on the metal back formed on the phosphor film. Accordingly, this often makes displaying of high luminance images unstable due to electric discharge that is generated by a high electric field applied between the metal back and an electron-emitting device.

### SUMMARY OF THE INVENTION

The present invention is directed to provide a device that is able to determine more correctly whether or not the According to an aspect of the present invention, a method for manufacturing a phosphor film containing phosphor particles is provided, and the method includes the steps of bringing a pressing member into contact with a precursor layer containing phosphor particles and an organic resin, and heating the precursor layer to a temperature at which the organic resin is thermally decomposed or above while the precursor layer is in contact with the pressing member.

According to another aspect of the present invention, a method for manufacturing a light emitting substrate including a phosphor film containing phosphor particles is provided, and the method includes the steps of bringing a pressing member into contact with a precursor layer that contains phosphor particles and an organic resin, and is located on a substrate, and heating the precursor layer to a temperature at which the organic resin is thermally decomposed or above while the precursor layer is in contact with the pressing member.

According to the present invention, floating of phosphor particles during baking can be restrained. In addition, generation of projections and air gaps in the phosphor film can be prevented. Accordingly, a phosphor film having a very smooth surface can be formed. Consequently, a display unit that provides stable display of high luminance images can be obtained.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B are schematic views illustrating a field emission display panel.

FIGS. 2A to 2F illustrate an exemplary embodiment of the present invention.

FIGS. 3A to 3D illustrate a modification of a baking step.

FIGS. 4A to 4D illustrate another exemplary embodiment of the present invention.

FIGS. 5A to 5C illustrate another exemplary embodiment of the present invention.

FIGS. 6A to 6E illustrate another exemplary embodiment of the present invention.

FIGS. 7A to 7E illustrate another exemplary embodiment of the present invention.

FIG. 8 is a schematic plan view of a part of a black matrix.

### DESCRIPTION OF THE EMBODIMENTS

Various exemplary embodiments, features, and aspects of the invention will be described in detail below with reference to the drawings.

Exemplary embodiments of a manufacturing method according to the present invention are described using a light emitting substrate in a field emission display (FED) as an example. The similar members are designated by the same reference numerals throughout the drawings.

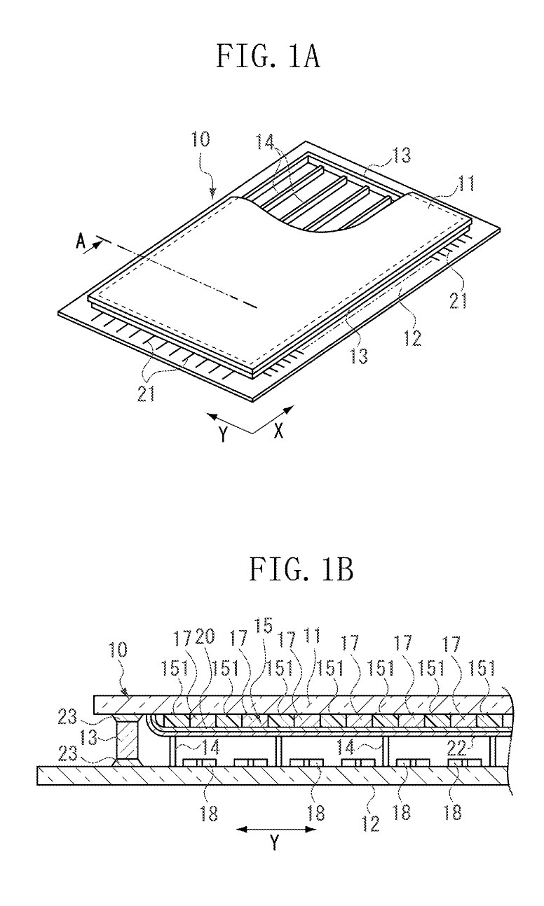

FIG. 1A is a perspective view illustrating an FED, and FIG. 1B is a schematic cross sectional view of the FED taken along the A-A line in FIG. 1A. The FED includes an air tight container 10 that is maintained at high vacuum.

As illustrated in FIG. 1A, the air tight container 10 includes a front substrate 11 and a rear substrate 12 that are both rectangular glass plates, and these substrates are arranged facing to each other at a distance of 1 to 2 mm. The front substrate 11 and the rear substrate 12 each have a thickness of 0.5 mm to 3 mm, and the thickness can be 2 mm or less. The front substrate 11 and the rear substrate 12 are connected together along their peripheries using sidewalls 13 in form of rectangular frames to maintain the space between the front substrate 11 and the rear substrate 12 at a high vacuum of about 10⁻⁴ Pa, which provides the flat rectangular air tight container 10. The distance (space) between the front substrate 11 and the rear substrate 12 is kept constant at a predetermined value of from 200 μm to 3 mm, more practically from 1 mm to 2 mm, for example.

The sidewalls 13 may be made of glass or metal, for example. An adhesive member 23 that has sealing function may be used as an adhesive for connection, such as low-melting glass and low-melting metal. When the adhesive member 23 is used to bond between the front substrate 11 and the rear substrate 12 and the sidewalls 13, the periphery of the front substrate 11 is sealed to the periphery of the rear substrate 12, and these substrates 11 and 12 are connected together. In the present exemplary embodiment, the connecting members include the sidewalls 13 and the adhesive member 23, but depending on the distance between the front substrate 11 and the rear substrate 12, the sidewalls 13 may be eliminated. In other words, connecting members of any structure may be used which can surround and hermetically seal the space between the front substrate 11 and the rear substrate 12 and that can connect the front substrate 11 to the rear substrate 12.

The rear substrate 12 has a surface opposite to the front substrate 11, and the surface is provided with a plurality of electron-emitting devices 18 arranged in a matrix. Each of the electron-emitting devices 18 is connected to a scanning wiring and a modulation wiring (not illustrated). The electron-emitting device 18 may be, for example, a conventional surface conduction electron-emitting device or a field emission electron-emitting device. The scanning wirings and the modulation wirings are pulled out of the air tight container 10 at their ends 21, as illustrated in FIG. 1A.

The front substrate 11 has a surface opposite to the rear substrate 12, and the surface is provided with a phosphor film 15 on which a plurality of light emission units 151 are arranged in a matrix corresponding to the plurality of electron-emitting devices 18 arranged in the matrix. Each of the light emission units 151 emits light by being irradiated with electrons emitted from one of the electron-emitting devices 18 corresponding to the light emission unit 151, and contains a plurality of phosphors particles. In FIG. 1B, a group of light emission units 151 that emits light of the same color are arranged in the Y direction, while the light emission units 151 that emit red light, the light emission units 151 that emit blue light, and the light emission units 151 that emit green light are arranged in the X direction (the direction perpendicular to the plane of FIG. 1B) repeatedly in a predetermined order.

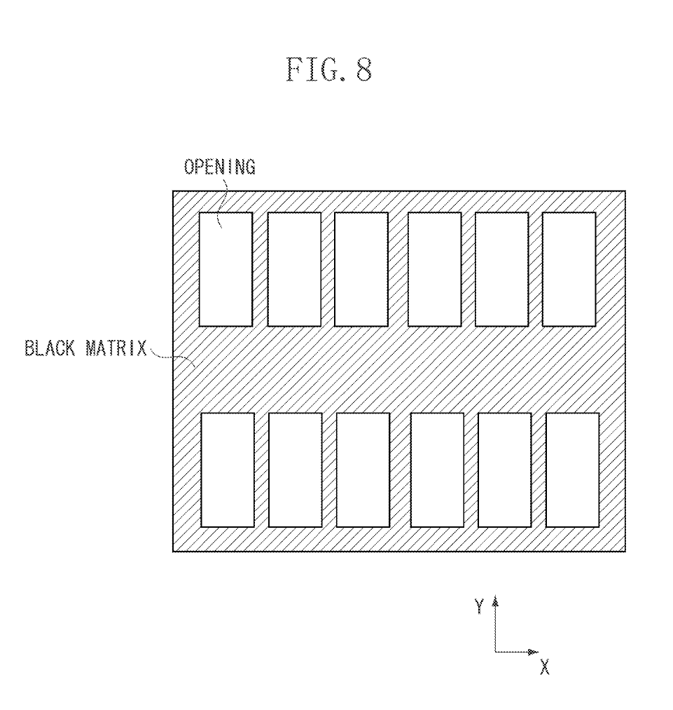

A light shielding member 17 which is generally referred to as black matrix is provided to spaces between adjacent light emission units 151. FIG. 8 is a schematic plan view of a part of the black matrix. As illustrated in FIG. 8, the black matrix includes openings corresponding to the light emission units respectively. In the case where the front substrate 11 is provided with a black matrix, both of the light emission units 151 and the light shielding member 17 are arranged on the phosphor film 15. Between the light emission units 151 and the front substrate 11, sometimes a color filter is further provided.

Each of the light emission units 151 corresponds to a pixel or picture element (subpixel). The phosphor film 15 is, on its rear substrate 12 side, provided with a metal back 20 that is basically made of aluminum and functions as an anode electrode. The metal back 20 may be, on its rear substrate 12 side, provided with a getter film 22. When display is operated, a predetermined anode voltage is applied to the metal back 20. The anode voltage may be within a range from 8 kV to 20 kV for example.

Between the rear substrate 12 and the front substrate 11, a large number of elongated plate-shape spacers 14 are provided to support the atmospheric pressure acting on these substrates. The plate-shape spacers 14 extend in a first direction X which extends along the longitudinal direction (the longer edge side direction) of the front substrate 11 and the rear substrate 12, while the direction perpendicular to the first direction X being a second direction Y (the width direction or shorter edge side direction). In other words, the plate-shape spacers 14 have a longitudinal direction 110 in the first direction X. The large number of plate-shape spacers 14 are arranged in the second direction Y at a predetermined interval. The interval in the second direction Y may be within a range from 1 mm to 50 mm for example.

Each of the spacers 14 may be a glass plate or ceramic plate. If necessary, each plate may be provided with a high resistance film or may have an irregular surface. The spacer 14 has a height (the length in the Z direction) that is several to a dozen of times the width (the length in the second direction Y), and has a length (the length in the second direction X) that is dozens to hundreds of times the height. The spacer 14 may be, however, eliminated from the air tight container 10 of small dimensions.

When a display having the above described air tight container 10 displays images, an anode voltage is applied to the phosphor film 15 via the metal back 20. Upon the application of the voltage, electron beams emitted from the electron-emitting devices 18 are accelerated by the anode voltage to strike phosphors. Accordingly, the light emission units 151 corresponding to the electron-emitting devices that emitted electrons are selectively excited, and an image can be displayed.

In FEDs, as described above, the front substrate 11, which has the phosphor film on its side facing to the rear substrate 12, functions as a light emitting substrate. In contrast, the rear substrate 12 may be referred to as an electron source substrate. In PDPs, a substrate located at a position corresponding to that of the rear substrate 12 of an FED is provided with a phosphor film, so that the substrate at the position corresponding to that of the rear substrate 12 of an FED functions as a light emitting substrate. Accordingly, a light emitting substrate according to the present invention refers to a substrate having a phosphor film.

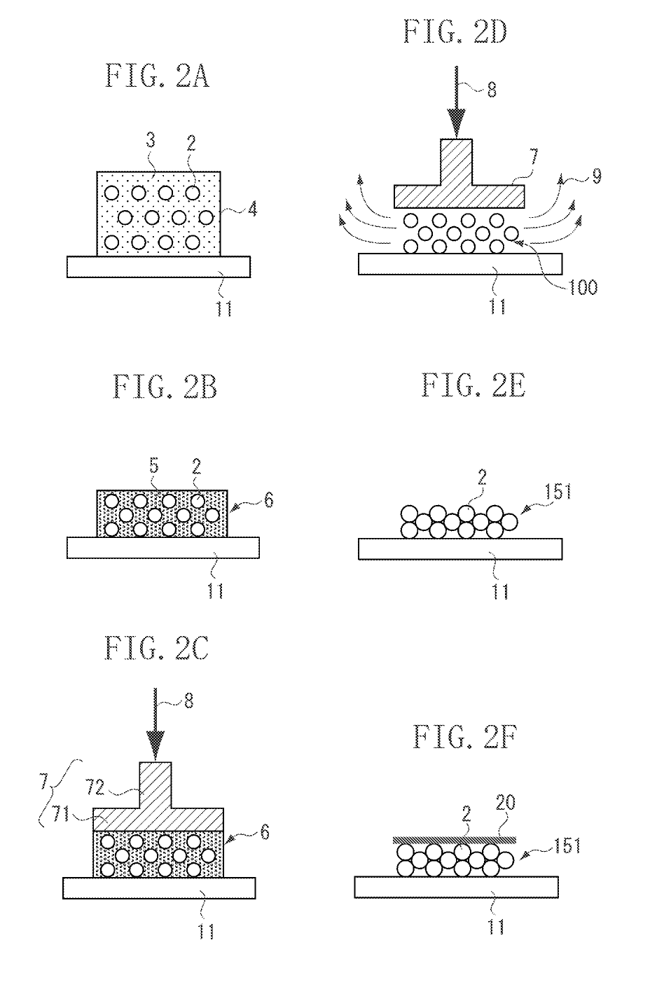

A method for manufacturing the phosphor film 15 in an FED is described with reference to FIGS. 2A to 2F. In FIGS. 2A to 2F, focus is kept on a single pixel (picture element) forming the phosphor film 15, and the cross sections of the pixel during the manufacturing steps are schematically illustrated.

### (Step 1) Coating Layer Forming Step

First, on a transparent substrate (e.g., glass substrate) for the front substrate 11, a phosphor paste containing a plurality of phosphors particles 2, an organic resin, and a solvent is coated to form a coating layer 4 (FIG. 2A). Not illustrated in figures, but the front substrate 11 may be provided with a black matrix having openings on the surface of the front substrate 11. In the case, the coating layer 4 is formed in each of the openings of the black matrix. The openings of the black matrix may be provided each with a color filter film. In the latter case, the coating layer 4 is formed in each of the openings of the black matrix and on the color filter film. The phosphor paste to be used in the present exemplary embodiment may be a conventional composition such as that containing a plurality of phosphors particles, a binder resin, a solvent, and an additive. The coating may be performed using printing, inkjet printing, or other conventional methods.

### (Step 2) Drying Step

Next, the coating layer 4 is dried, so that the solvent contained in the coating layer 4 is removed, and a precursor layer 6 containing the plurality of phosphor particles 2 and the organic resin 5 (and the other solid components) (FIG. 2B). For the drying, any conventional conditions and methods may be used. The other solid components include conventional organic or inorganic additives such as binding agents, surface active agents, and thickening agents, all of which are optional.

### (Step 3) Pressing Member Placement Step

A pressing member 7 is brought into contact with a surface of the precursor layer 6 (FIG. 2C). The term “contact” as used herein can be expressed as “pressing” or “abutting”.

In the contact operation, if the pressing member 7 covers all over the surface of the precursor layer 6, a path through which decomposition gas is released may be blocked, the gas being generated by thermal decomposition of the organic resin contained in the precursor layer 6 in a baking step which will be described below. The path is desirably secured to release the decomposition gas. Thus, the pressing member 7 is brought into contact with the surface of the precursor layer precursor layer 6, with a part (typically, at the peripheral part) of the surface being kept open (without contact with the precursor layer 6) (i.e., the remaining surface part except the peripheral surface part of the precursor layer 6 is covered with the pressing member 7).

The pressing member 7 is required to be made of a material that is heat resistant to a baking temperature in the baking step which will be described below and that does not deform at the baking temperature. Desirable examples of the material include metals and ceramics. The pressing member 7 has a pressing portion 71 that is brought into contact with the precursor layer 6. The pressing portion 71 is desirably made of a material having excellent mold release properties from the precursor layer 6 and excellent heat resistance, and that may be selected from metals, compounds of metal, metal oxides, and metal nitrides as needed. For example, the material can be selected from Ni, Cr, Mo, Ti, Ta, Au, B, Pt, W, WC, SiC, SiN, AlN, and BN that do not suffer from oxidative degradation at elevated temperatures.

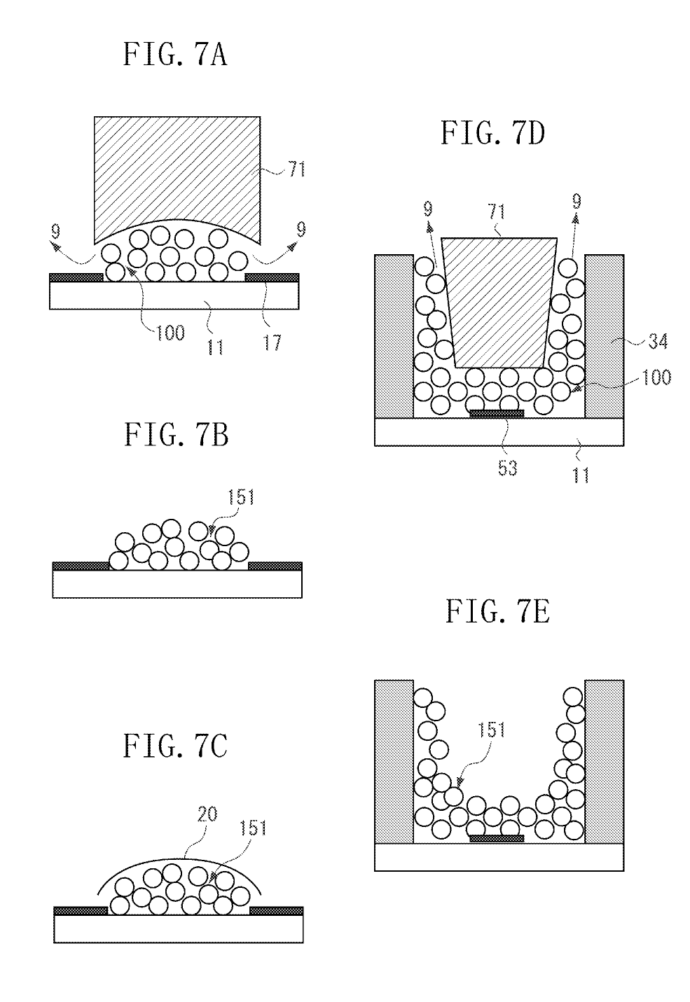

The pressing member 7 may have a shape other than that illustrated in FIG. 2C. The pressing portion 71 of the pressing member 7 that is brought into contact with the precursor layer 6 may have a shape other than the flat sheet shape illustrated in FIG. 2C. For example, as illustrated in FIG. 7A and FIG. 7D, the shape of the pressing portion 71 may be conveniently changed depending on the final surface profile of the phosphor film 15 (light emission units 151). The pressing portion 71 of the pressing member 7, however, is required to have at least enough rigidity that prevents itself from lifting due to generated composition gas.

The pressing portion 71 made of metals or ceramics may have a thickness of about 100 μm or more. The pressing portion 71 may have surface roughness that can make the final surface of the phosphor film 15 smooth, but practically, needs to have surface roughness Ra that is 20% or less of the mean particle diameter of the plurality of phosphors 2 contained in the precursor layer 6. The mean particle diameter of phosphors 2 used in displays typically ranges from 2 μm to 10 μm, and thereby the surface roughness Ra can be from 0.4 μm to 2 μm or less.

In the present invention, the “average particle size” is defined by a median diameter (i.e., the median value d50 of a particle size distribution), and can be obtained statistically from particle size distribution (particle diameter distribution) based on sphere equivalent diameters. The particle size distribution can be measured by a dynamic light scattering method or a laser diffraction scattering method. JIS Z8901-2006 may be referred to on the particle diameter. The “surface roughness” can be evaluated using an arithmetical mean roughness Ra according to JIS B0601-2001.

In the present exemplary embodiment, a single pixel (picture element) of the phosphor film 15 is used for description, but the phosphor film 15 includes a large number of pixels (picture elements). Accordingly, the operation to bring the pressing member 7 into contact with the precursor layer 6 is desirably performed to the plurality of precursor layers 6 corresponding to the plurality of pixel (the plurality of picture elements) at one time. The pressing portions 71 then can be connected together by a supporting portion 72 to respectively correspond to the precursor layers 6 of the plurality of pixels (the plurality of picture elements). In addition, an adjustment is required between the relative positions of each of the pixels (each picture element) and the pressing portions 71. Thus, for example, a relative position adjustment mechanism can be provided at the peripheral portion of the pressing member 7 to adjust the relative positions between each of the pixels (each picture element) and the pressing portions 71.

In the baking step which will be described below, the pressing member 7 is heated to a baking temperature of the precursor layer 6, and then cooled. Accordingly, the relative position adjustment mechanism is required to further have a function to prevent misalignment between relative positions of the pressing member 7 and the precursor layer 6, more specifically, a function to follow the thermal expansion and contraction of the front substrate 11. Thus, for example, the material of the front substrate 11 can have a thermal expansion coefficient equal to that of the material of the pressing member 7.

For the reason, the front substrate 11 and the pressing member 7 can be formed of the same material, more specifically the same glass material. The pressing member 7 desirably contacts the precursor layer 6 at a zero or low pressure, so that the pressing member 7 can define a surface profile of the precursor layer 6 in the baking step. There is no need to aggressively pressurize the precursor layer 6 using the pressing member 7. Only the placement of the pressing member 7 onto the precursor layer 6 of each pixel (each picture element) may be enough. In other words, the weight of the pressing member 7 can cover the required contact pressure. Alternatively, a height adjustment mechanism may be mounted to a peripheral portion of the coupled pressing member 7 to define the height of the pressing member 7, so that the contact pressure of the pressing member 7 to the precursor layer 6 can be controlled.

The contact pressure refers to a load (pressure) per unit area that is applied by the pressing portion 71 of the pressing member 7 to a contact surface of the precursor layer 6 in the vertical direction when the pressing portion 71 presses the contact surface.

The above “low pressure” indicates a pressure exerted only by the weight of the pressing member 7 having a glass thickness of 0.7 mm which will be described in Examples below. More specifically, the “low pressure” is 0.3 KPa or less (based on the dimensions of Examples, the contact pressure=0.002875 Kg/cm²=0.27 KPa, where the specific gravity of glass=2.5). The value is extremely low in comparison with the pressures used in general pressure sintering of ceramics (e.g., hot pressing method: about 50 MPa, gas pressure sintering method: 0.2 MPa to 10 MPa, hot isostatic pressing (HIP): 100 MPa to 300 MPa).

In the placement step, the pressing member 7 (pressing portion 71) directly contacts the precursor layer 6, but the contact pressure is set to be zero or more. The situation in which the pressing member 7 (pressing portion 71) directly contacts the precursor layer 6 at a contact pressure of zero can be said that the pressing member 7 (pressing portion 71) is simply attached to the precursor layer 6. In the present invention, such situation is, however, also within the scope of the contact of the pressing member 7 (pressing portion 71) with (pressing against) the precursor layer 6. This is because the pressing member 7 (pressing portion 71) in the situation can suppress an amount of floating of the phosphor particles 2 even if the phosphor particles 2 float in the baking step as in the conventional art. Such suppression can control the surface of each of the light emission units 151 (phosphor films 15) to have a predetermined profile.

In the present exemplary embodiment, the pressing member 7 moves toward the precursor layer 6 to contact (press) the precursor layer 6. On the contrary, the precursor layer 6 may move toward the pressing member 7 to contact (press) the pressing member 7. Alternatively, both of the precursor layer 6 and the pressing member 7 may move to each other to contact (press) each other.

### (Step 4) Baking Step

The precursor layer 6 is heated to a temperature at which the organic resin 5 contained in the precursor layer 6 starts thermal decomposition or a higher temperature, to remove the organic resin 5 through the thermal decomposition (FIG. 2D). Through the thermal decomposition, the organic resin 5 generates decomposition gas 9, and the decomposition gas 9 is released through a discharge path that is intentionally established for the gas (the path at the peripheral portion of the precursor layer 6 in FIG. 2D). The temperature for thermal decomposition is typically set to be within a range from 400 to 550 degrees Celsius. A time period for baking is conveniently set to be within a range from 30 to 300 minutes.

In the present exemplary embodiment, the step 3, i.e. the pressing member placement step, is separated from the step 4 i.e. the baking step, however, the step 3 and the step 4 may be simultaneously performed. For example, after the temperature starts to rise in the baking step, the pressing member 7 may be brought into contact with the precursor layer 6. In the case, the pressing member 7 can be brought into contact with the precursor layer 6 before the temperature reaches a temperature for thermal decomposition of the organic resin 5. Desirably in terms of accuracy of alignment, after the pressing member 7 is brought into contact with the precursor layer 6, the temperature starts to rise in the baking step while the contacted state is maintained.

### (Step 5) Pressing Member Removing Step

When the baking step is completed (typically, after the structure is cooled to the ambient temperature), the pressing member 7 is removed from the front substrate 11 to obtain light emission units 151 of the phosphor film 15 (FIG. 2E). The pressing member 7 may be removed from the front substrate 11 in the middle of the step 4 if the organic resin 5 is already sufficiently removed through thermal decomposition.

### (Step 6) Metal Back Forming Step

An aluminum film is usually formed on the light emission units 151 (phosphor film 15) as the metal back 20 (FIG. 2F). The metal back forming step may be performed by conventional methods. Typically, a lacquer mainly containing acrylic resin is coated on the light emission units 151 (phosphor film 15) and is dried there to obtain a resin film (flattened film). An aluminum film is then deposited on the resin film. The resin film is removed through thermal decomposition in a baking step. After removal of the resin film by thermal decomposition, the aluminum film is left as the metal back 20 on the light emission units 151 (phosphor film 15).

Through these steps, the front substrate 11 can be obtained, the front substrate 11 having a smooth metal back 20 formed on the phosphor film 15 with a predetermined surface profile.

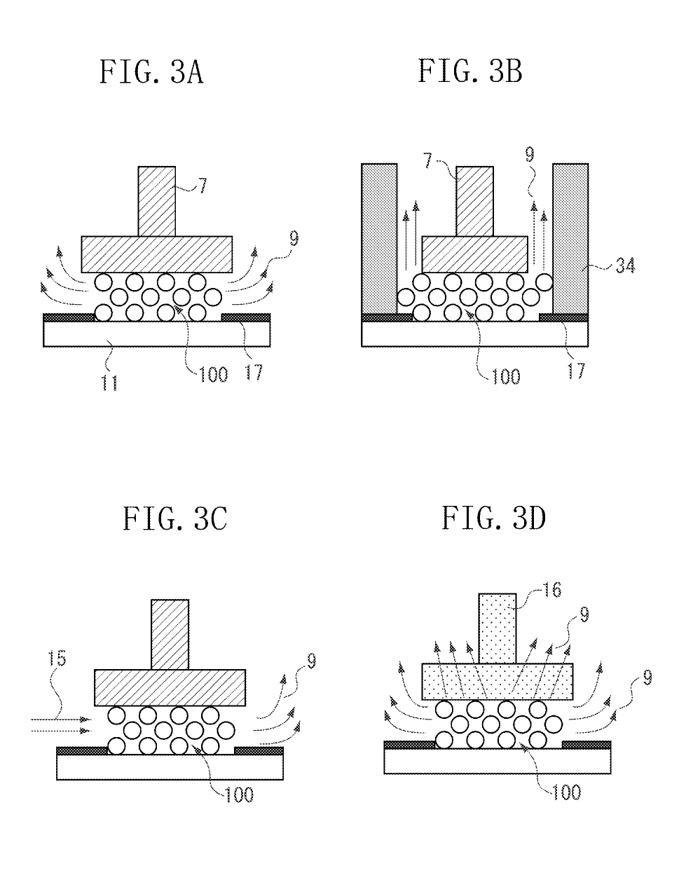

In the baking step of the precursor layer 6, it is important to sufficiently remove the decomposition gas 9 from the organic resin 5 contained in the precursor layer 6. Modifications for the removal are described below with reference to FIGS. 3A to 3D.

Each of the configurations in FIGS. 3A to 3D illustrates the baking step of the precursor layer 6 that is disposed in each of the openings of a black matrix 13 on the front substrate 11. In FIGS. 3A to 3D, a precursor layer 100 under baking (under thermal decomposition) is separately illustrated from the precursor layer 6 before baking.

FIG. 3A illustrates a configuration in which paths for releasing the decomposition gas 9 are provided along the direction of each side surface of the precursor layer 100 that is under thermal decomposition. The configuration is substantially similar to the configuration illustrated in FIG. 2D where the black matrix 13 is not illustrated.

FIG. 3B illustrates a configuration in which partition walls 34 are placed on the black matrix 17 or between adjacent precursor layers 6. In this case, the peripheral portion of the upper surface of the precursor layer 100 that is under thermal decomposition is not covered (kept open), as illustrated in FIG. 3B, so that upward paths for releasing the decomposition gas 9 are established. This configuration ensures release of the decomposition gas 9.

FIG. 3C illustrates a configuration in which, in the baking step, oxygen gas or oxygen-containing gas is forcibly supplied into the precursor layer 100 that is under thermal decomposition, so that decomposition of the organic resin 5 is accelerated and completed with high reliability. As a method for supplying oxygen gas or oxygen-containing gas, a nozzle to supply oxygen gas or oxygen-containing gas to each pixel (each picture element) and a nozzle to suck the generated gas may be provided.

Alternatively, the baking step may be performed in a chamber maintained at a pressure lower than the atmosphere pressure, so that oxygen gas or oxygen-containing gas can be supplied to the chamber during the baking step. Otherwise, decompression of the chamber and supply of the oxygen gas or oxygen-containing gas may be alternately repeated. Use of either of these methods enables sufficient thermal decomposition of the organic resin 5 and reliable release of the decomposition gas 9 even in the baking step in which the surface of the precursor layer 6 is covered with a pressing member.

FIG. 3D illustrates a configuration in which the pressing member 7 is made of a porous material 16, so that the decomposition gas 9 can be released through pores in the pressing member 7. In the configuration, many pores are interconnected to one another in the porous material, and the holes resulted from the interconnection (interconnected holes) function as a release path of the decomposition gas 9. In this case, the decomposition gas 9 generated in the baking step can be released from the side surfaces of the precursor layer 100 under thermal decomposition and also through the interconnected holes in the pressing member 7 (16).

In the configuration illustrated in FIG. 3D, especially the decomposition gas 9 generated around the center of the precursor layer 100 under thermal decomposition is released more easily than in the configuration illustrated in FIG. 3A. The porous material 16 used in the configuration of FIG. 3D may be a metal or ceramics having a surface roughness Ra that satisfies the above conditions and having the above described interconnected holes. For example, a porous glass material having interconnected holes of a diameter ranging from several tens nm to several hundreds nm (e.g., PC-PL series manufactured by Nippon Sheet Glass Co., Ltd.) or a vacuum chuck material (e.g., ceramics manufactured by Nippon Tungsten Co., Ltd.) may be used.

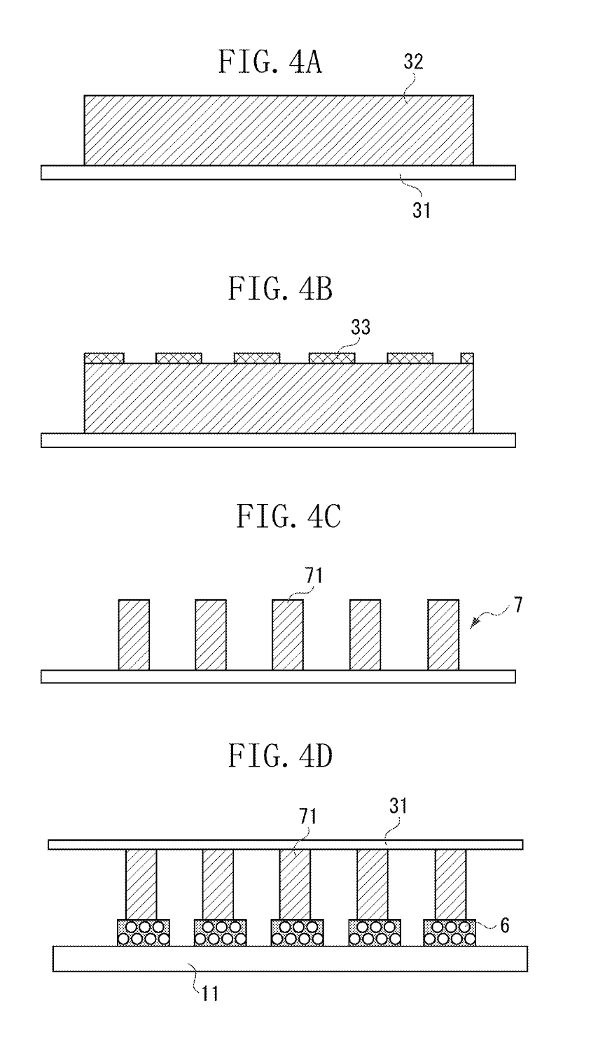

One displays includes more than a million of light emission units (pixels or picture elements). To form a phosphor film used in a display, a huge number of precursor layers 6 are arranged on one substrate. Accordingly, a simultaneous application of the pressing member placement step and the baking step to the precursor layers 6 is needed to reduce manufacturing cost and time. One example of the pressing member 7 corresponding to a plurality of pixels (a plurality of picture elements) is described with reference to FIGS. 4A to 4C.

First, a glass frit layer 32 which is resistant to a temperature used in the baking step is formed on a substrate 31. The substrate 31 is made of the same material as that of the front substrate 11 of the display and functions as the supporting portion 72 of the pressing member 7 (FIG. 4A). The glass frit layer 32 can be formed by applying a paste containing glass frit to the substrate 31, and drying and baking the paste. The paste is applied to a thickness corresponding to the height of a pressing member after drying and baking.

Next, a dry film resist 33 is put on the glass frit layer 32, which is subjected to exposure, development, and patterning (FIG. 4B). The patterned dry film resists 33 are arranged to respectively correspond to the pixels (picture elements).

The glass frit layer 32 is sandblasted using the patterned dry film resists 33 as mask. After the sandblasting, the patterned dry film resists 33 are removed from the glass frit layer 32, so that the pressing member 7 having a plurality of pressing portion 71 respectively corresponding to the pixels (picture elements) is formed (FIG. 4C).

The above described steps may be performed by an approach used in a conventional method for forming partition walls (ribs) of a PDP.

After removing of the dry film resist 33, a Cr film can be formed by sputtering or other methods on the surface of the pressing member 7 (surfaces of the pressing portion 71) to enhance the mold release property.

The pressing portions 71 formed by the steps in FIGS. 4A to 4C are respectively placed on the precursor layers 6 (FIG. 4D), which are subjected to the baking step to form a huge number of phosphor films (light emission units) at one time. In the present exemplary embodiment, because the substrate 31 is made of the same material as that of the front substrate 11, misalignment due to thermal expansion difference between the front substrate 11 and the pressing member 7 in the baking step can be avoided.

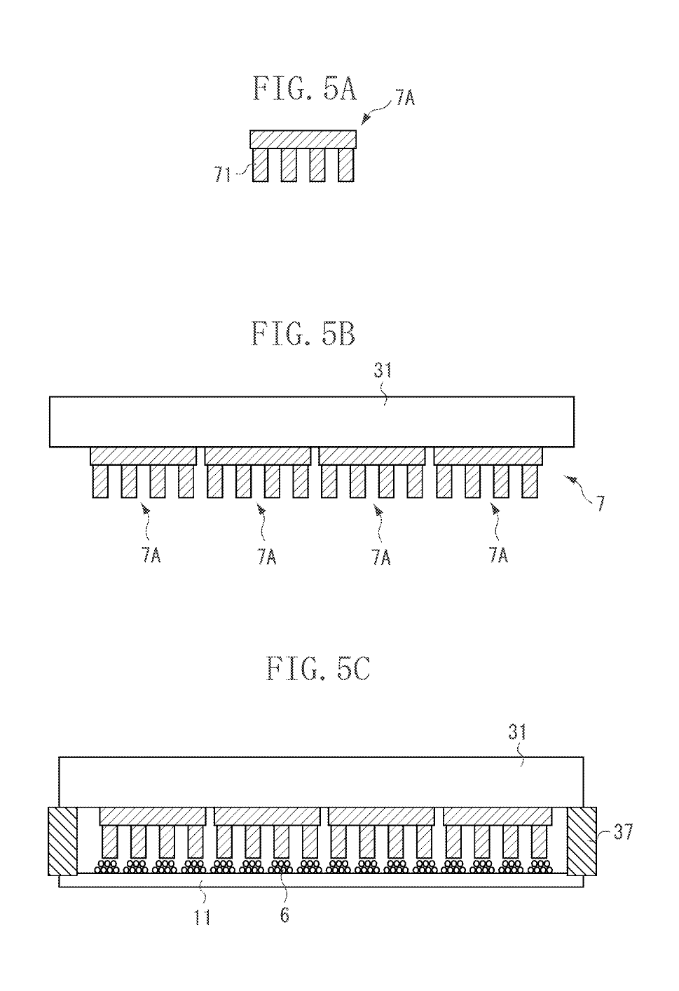

If it is difficult to form the pressing portions 71 corresponding to respective light emission units at one time for a larger size of a display, the pressing portions 71 can be divided into several blocks for formation thereof. A method for manufacturing the press ing member 7 by combining a plurality of pressing member blocks 7A and a configuration thereof are described with reference to FIGS. 5A and 5B.

First, a pressing member block 7A of a predetermined shape is prepared by processing an alloy material that has a coefficient of linear expansion similar to that of glass by machining or etching (FIG. 5A). The pressing member block 7A is a unit portion of the pressing member 7. The pressing member block 7A includes a plurality of pressing portions 71. The alloy material that has a coefficient of linear expansion similar to that of glass may be invar (Ni: 34 to 38%, Fe: balance) or 426 alloy (Ni: 38 to 44%, Cr: 4 to 8%, Fe: balance).

The pressing member block 7A may be of any size without limitation. The size can be determined in view of the thermal expansion difference between the front substrate 11 and the pressing member block 7A occurred in the baking step. For example, six pieces of the pressing member blocks 7A can be prepared for a display of dimensions of about 900 mm by 600 mm.

Next, as illustrated in FIG. 5B, the pressing member blocks 7A are attached to the substrate 31 using a heat resistant adhesive. The substrate 31 is made of the same material as that of the front substrate 11 and functions as a support of the pressing member 7. As a result, the pressing member 7 having the plurality of pressing member blocks 7A is obtained. FIG. 5B is a schematic view illustrating four pressing member blocks 7A. The number of the pressing member blocks 7A can be conveniently selected in view of size of a display for example, as described above. The quartz substrate 31 in the present exemplary embodiment needs to have a thickness sufficient to prevent deformation of the substrate 31 due to its own weight (bending due to its own weight).

The resulting pressing member 7 is, as illustrated in FIG. 5C, pressed against the precursor layer 6 while the substrate 31 is supported at the peripheral portion by a height adjustment mechanism 37 located between the front substrate 11 and the substrate 31. In this state, the other steps following the baking step are performed to form a phosphor film. In the present exemplary embodiment, the height adjustment mechanism 37 is located between the front substrate 11 and the substrate 31. However, the height adjustment mechanism 37 may be located at the other position and have the other configuration. There is no limitation on configuration and position of the height adjustment mechanism 37 that can adjust the position of the pressing member 7 relative to the front substrate 11 (relative to the precursor layer 6) as predetermined.

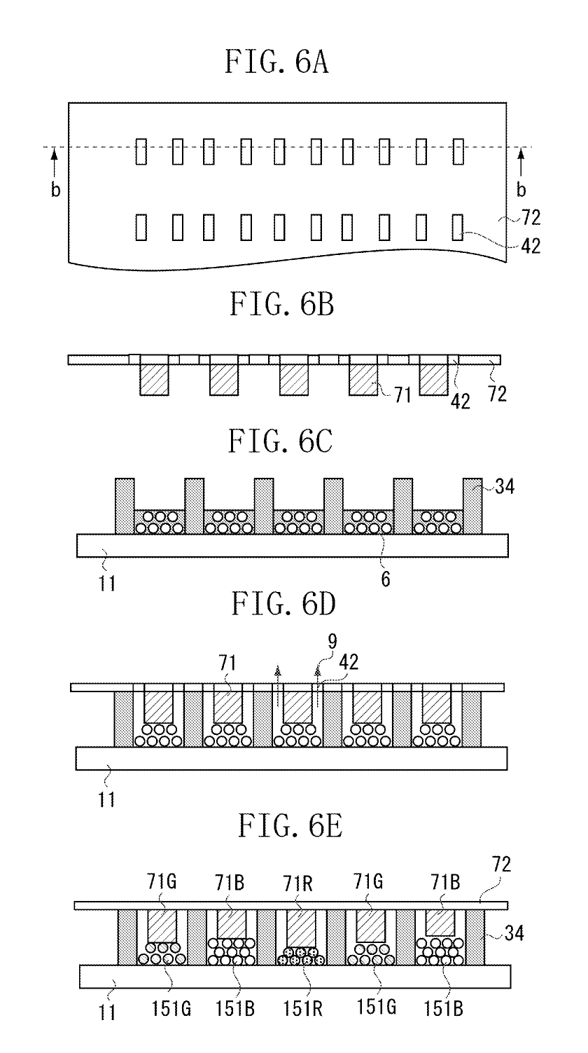

A method for manufacturing the pressing member 7 when partition walls 34 are located between pixels (picture elements) and a configuration of the pressing member 7 are described with reference to FIGS. 6A to 6E. FIG. 6A is a schematic top plan view illustrating the pressing member 7. FIG. 6B is a schematic cross sectional view illustrating the pressing member 7 of FIG. 6A taken along the b-b line.

As illustrated in FIG. 6A, a plate-shape supporting portion 72 of the pressing member 7 is formed. The supporting portion 72 is provided with a plurality of openings 42 that function as paths to release the decomposition gas 9 in the baking step. Similar to those described with reference to FIGS. 4A to 4D, a plurality of pressing portions 71 are formed between the openings 42 on the plate-shape supporting portion 72 as illustrated in FIG. 6B.

The thus formed pressing member 7 is placed, as illustrated in FIG. 6D, on the front substrate 11 having the precursor layers 6 between the partition walls 34 of FIG. 6C, so that the pressing portions 71 are respectively pressed against the precursor layers 6. It is important to set the height of the pressing portions 71 from the supporting portion 72 by the partition walls 34 such that the partition walls 34 can adjust the height of the supporting portion 72 (pressing portions 71) from the front substrate 11. In the baking step, the generated decomposition gas 9 from the organic resin 5 is released through the preset openings 42, as illustrated in FIG. 6D. This method can eliminate the height adjustment mechanism 37 in FIG. 5C, and enables more uniform pressing.

FIG. 6E illustrates a configuration in which green light emission units 151G, red light emission units 151R, and blue light emission units 151B included in the phosphor film phosphor film 15 each have a different film thickness. In the present exemplary embodiment, the baking step similar to that in FIG. 6C is basically performed, but pressing portions 71R, 71G, and 71B respectively having a different height corresponding to the light emission units 151G, 151R, and 151B are formed. In the present exemplary embodiment, the pressing portions 71 can be respectively placed at predetermined positions on a plurality of precursor layers 6 having different thickness.

FIGS. 7A to 7C illustrate configurations in which non-flat pressing portions 71 are used. When a pressing member 71 having a curved surface (concave toward the front substrate 11) as illustrated in FIG. 7A is used, in the baking step, the precursor layer 100 under thermal decomposition is going to have a surface following the surface profile of the pressing portion 71. As a result, a light emission units 151 (phosphor film 15) having a curved surface can be manufactured (FIG. 7B)

A metal back 20 can be formed on the surface of the light emission units 151 (phosphor film 15) using the above described conventional approach, so that the light emission units 151 (phosphor film 15) having a curved surface and the metal back also having a curved surface can be provided on the front substrate 11. Consequently, among light emitted from the light emission units 151, the light advancing away from the front substrate 11 can be efficiently reflected toward the front substrate 11.

FIG. 7D illustrates a configuration in which a manufacturing method according to the present invention is applied to a method for manufacturing a phosphor film on a light emitting substrate that is used in a plasma display. In FIG. 7D also, focus is kept on a single pixel (picture element) forming the phosphor film 15, and the cross section of the pixel during the manufacturing process is schematically illustrated.

In the baking step, a pressing member 71 having a trapezoidal cross section as illustrated in FIG. 7D is pressed against the precursor layer 6 lying in an area surrounded by the partition walls 34, which causes the precursor layer 100 under thermal decomposition to have a surface following the surface profile of the pressing portion 71. As a result, as illustrated in FIG. 7E, the light emission units 151 (phosphor film 15) having a surface of a cross section similar to the inverted trapezoidal shape can be obtained. In FIGS. 7D and 7E, an address electrode 53 is provided on the front substrate 11. Between the address electrode 53 and the light emission units 151 (phosphor film 15), usually a dielectric material layer (not illustrated for simplicity) is provided.

Accordingly, a plasma display panel (PDP) having a light emitting substrate with a phosphor film configured with the light emission units 151 that are controlled to have a predetermined design surface profile can be manufactured. This results in a PDP having excellent light emitting properties.

Specific examples are described.

### Example 1

A method for fabricating a pressing member 7 of an Example 1 is described with reference to FIGS. 4A to 4D.

Bismuth oxide-based glass frit past (NP7753 manufactured by Noritake Co. Ltd.) was coated by a slit coater on a substrate 31 made of a blue plate glass (soda lime glass) (coefficient of linear expansion: 8*10⁻⁶/degrees Celsius) to a thickness that provided a film of 100 μm thickness after baking. The substrate 31 had dimensions of 300 mm*240 mm*0.7 mm (thickness). The substrate 31 corresponds to the supporting portion 72 of the pressing member 7.

The paste on the substrate 31 was dried at a temperature of 120 degrees Celsius for 10 minutes. On the paste, a dry film resist (DFR) 33 was laminated using a laminating apparatus. A chrome mask for exposure was aligned at a predetermined position, and the substrate was subjected to exposure, development using a developer for the DFR, rinsing, and drying. Through these steps, a mask for sandblasting was formed. The mask was a stripe shaped dry film resist 33 provided with openings of a width of 140 μm at a pitch of 210 μm (FIG. 4B).

Then, parts of the dried glass frit paste layer 32 exposed to the openings of the DFR 33 were sandblasted using steel use stainless (SUS) grains, and removed. The DFR 33 were then rinsed with remover and removed. After cleaning, the remaining glass frit paste layers 32 were baked at a temperature of 530 degrees Celsius to obtain the pressing member 7 (FIG. 4C).

To impart the mold release property to the pressing portions 71, a Cr film was coated on each surface of the pressing portions 71 to a thickness of 150 nm using a spattering device.

The surface of the pressing portion 71 was measured to find that the surface had a surface roughness Ra of 0.2 μm, which indicated a smooth surface.

On the other hand, a black matrix of a thickness of 2 μm comprising black cobalt pigment-based material was formed on a surface of a glass substrate 11 which is formed of the same material as that of the substrate 31 and having dimensions of 300 mm*240 mm*2 mm (thickness), using photolithography. As partially illustrated in the schematic plan view in FIG. 8, the black matrix is provided with a plurality of openings having dimensions of 140 μm (the length in the X direction in FIG. 1) by 200 μm (the length in the Y direction in FIG. 1). The openings were arranged at a shorter pitch of 210 μm (the pitch in the X direction in FIG. 1) and a longer pitch of 630 μm (the pitch in the Y direction in FIG. 1). FIG. 8 is a partial plan view illustrating the black matrix.

Next, a blue phosphor paste was prepared. The paste includes 45 weight % of ZnS-based blue phosphor having a mean particle diameter of 5.0 μm (commercially available P22 phosphor), 25 weight % of ethyl cellulose resin, and 30 weight % of butyl carbitol acetate. The blue phosphor paste was screen printed in each of the openings of the black matrix, and dried for 10 minutes at a temperature of 130 degrees Celsius to obtain a substrate 11 having a precursor layer 6 in each opening of the black matrix. The precursor layer 6 had an average film thickness of 11 μm.

Using an XY alignment mechanism (not illustrated) having a micrometer and a reference surface SUS block, the pressing members 71 were aligned on the precursor layers 6 such that each of the pressing portions 71 of the pressing member 7 could be placed onto a corresponding precursor layer 6, and the pressing member 7 was brought into contact with the front substrate 11 (FIG. 4D). At this point of time, the contact pressure was calculated to be 0.274 MPa according to the equation: the specific gravity of glass of the substrate 31≈the specific gravity of glass frit of the pressing portions 71≈2.5.

The front substrate 11 having the pressing member 7 placed thereon was baked in a baking furnace for 100 minutes at a temperature of 450 degrees Celsius that was above the temperature at which the resin in the precursor layer is thermally decomposed.

After cooled, the pressing member 7 was removed from the front substrate 11, which resulted in the front substrate 11 having the phosphor film. 15 including the plurality of light emission units 151 and the black matrix.

Apart of the thus formed phosphor film 15 (the light emission units 151) was cut, and the surface and cross section of the cut part were observed under an electron microscope, to find that the phosphor film 15 was provided with the light emission units 151 having smooth surface profiles. The phosphor film 15 (the light emission units 151) had an average film thickness of 10 μm.

Next, an acrylic emulsion as a flatting agent was coated all over the phosphor film 15 using spray coating, and dried to obtain a resin film on the phosphor film 15. Then, an aluminum film was deposited on the resin film to form a metal back 20 of a thickness of 100 nm. Finally, the structure was baked for 100 minutes at a temperature of 450 degrees Celsius to remove the resin film through thermal decomposition, to obtain the metal back 20 continuously covering the light emission units 151 (phosphor film 15) (FIG. 2F).

The surface of the metal back 20 was measured to find that the surface had a roughness Ra of 0.45 μm, which indicated a smooth surface. The surface of the metal back 20 was further observed under microscope, and a magnified image of the surface was processed to find that the surface had a low pinhole rate of 2.8%.

The front substrate 11 was put into a vacuum chamber in which an electron gun was placed for measuring a light-emitting luminance of the phosphor film 15, and a voltage of 10 KV was applied to the metal back 20 to be irradiated with electron beams under a current density of 5.5 mA/cm². In this state, the light-emitting luminance observed from the surface of the front substrate 11 (the side opposite to that with the phosphor film 15) was measured using a luminance meter (TOPCON spectroradiometer SR-3 manufactured by TOPCON CORPORATION). The measured luminance was 810 cd/m².

### Comparative Example 1

A front substrate 11 having a black matrix and a precursor layer 6 was fabricated, as in the Example 1.

Unlike to the Example 1, without using a pressing member 7, a baking step was performed on the front substrate 11 as in the Example 1. The structure was then cooled to the ambient temperature to obtain the front substrate 11 having the phosphor film 15 including the plurality of light emission units 151 and the black matrix.

A part of the formed phosphor film 15 (the light emission units 151) was cut, and the surface and cross section of the cut part were observed under an electron microscope, to find that the phosphor film 15 (the light emission units 151) was lifted at several points which formed projections.

A metal back 20 was formed on the phosphor film 15 as in the Example 1, and the surface of the metal back 20 was measured to find that the surface had a roughness Ra of 0.68 μm, which was a larger surface roughness than those in the Examples 1 and 2.

The surface of the metal back 20 of the Comparative Example 1 was observed under microscope, and a magnified image of the surface was processed to find that the surface had a low pinhole rate of 4.2%, which was larger than the value in the Example 1.

The light-emitting luminance observed from the front substrate 11 of the Comparative Example 1 was measured as in the Example 1. The measured luminance was 780 cd/m² which indicated that the surface had a much lower luminance than those in the Examples 1 and 2.

### Example 2

In an Example 2, an FED 10 illustrated in FIGS. 1A and 1B was fabricated using the front substrate 11 of the Example 1.

As illustrated in FIGS. 1A and 1B, in the Example 2, surface conduction electron-emitting devices 18 were formed in a matrix on a rear substrate 12. The number of the electron-emitting devices 18 was the same as that of the pixels (picture elements) on the front substrate 11 so that the pixels could correspond to the electron-emitting devices 18 respectively.

Modulation wirings (not illustrated) were arranged in the Y direction to be connected to each of the plurality of surface conduction electron-emitting devices 18, and then, scanning wirings (not illustrated) were arranged in the X direction to be connected to each of the plurality of surface conduction electron-emitting devices 18. At each of intersections between the scanning wirings and the modulation wirings, insulating layers were provided to electrically insulate the scanning wirings from the modulation wirings. The scanning wirings, the modulation wirings, and the insulating layers of the Example 2 were formed by printing a photosensitive print paste on the rear substrate 12, and performing steps of drying, exposure, development, and baking on the paste.

Then, plate-shape spacers 14 having a height of 1.7 mm were fixed onto the rear substrate 12 using an adhesive, and rectangular frame-shape sidewalls 13 were fixed on the rear substrate 12 using a glass frit 23.

The front substrate 11 fabricated in the Example 1 was placed opposite to the rear substrate 12 in a vacuum chamber, with the plate-shape spacers 14 and the sidewalls 13 being sandwiched therebetween. The chamber was maintained at a pressure of 10-5 Pa, and the front substrate 11 and the rear substrate 12 were bonded together by indium 23. In this way, one hundred FEDs illustrated in FIGS. 1A and 1B were fabricated, the inside thereof being maintained at a high vacuum.

Each of the metal back 20 of the FEDs 10 of the Example 2 was applied with a voltage of 10 kV to cause electrons to be projected from the electron-emitting devices 18 to display an image. As a result, no phenomenon like electric discharge was observed, and an image with high quality was displayed for a long period of time.

### Comparative Example 2

In a Comparative Example 2, one hundred FEDs illustrated in FIGS. 1A and 1B were fabricated as in the Example 2 using the front substrate 11 fabricated in the Comparative Example 1. Each of the metal back 20 of the FEDs of the Comparative Example 2 was applied with a voltage of 10 kV to cause electrons to be projected from the electron-emitting devices 18 to display an image. As a result, there were a lot of FEDs in which light emission phenomena due to electric discharge were observed. Such FEDs did not provide an image with high quality for a long period of time as compared to the Example 2.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-095093 filed Apr. 16, 2010, which is hereby incorporated by reference herein in its entirety.

What is claimed is:

1. A method for manufacturing a phosphor film containing phosphor particles, comprising the steps of:
bringing a pressing member into contact with a precursor layer containing phosphor particles and an organic resin; and
heating the precursor layer to a temperature at which the organic resin is thermally decomposed or above while the precursor layer is in contact with the pressing member.

2. The method for manufacturing a phosphor film according to claim 1, wherein, in the bringing step, the pressing member is brought into contact with a part of a surface of the precursor layer to cover the part of the surface of the precursor layer with the pressing member.

3. The method for manufacturing a phosphor film according to claim 1, wherein the pressing member comprises a porous material, and wherein, in the heating step, the organic resin generates a gas through thermal decomposition, and the gas is released through the pressing member.

4. A method for manufacturing a light emitting substrate including a phosphor film containing phosphor particles, comprising the steps of:
bringing a pressing member into contact with a precursor layer that contains phosphor particles and an organic resin, and is located on a substrate; and
heating the precursor layer to a temperature at which the organic resin is thermally decomposed or above while the precursor layer is in contact with the pressing member.

5. The method for manufacturing a light emitting substrate according to claim 4, further comprising a step of forming a metal back on the phosphor particles after the heating step.

6. The method for manufacturing a light emitting substrate according to claim 5, wherein, in the bringing step, the pressing member is brought into contact with a part of a surface of the precursor layer to cover the part of the surface of the precursor layer with the pressing member.

7. The method for manufacturing a light emitting substrate according to claim 4, wherein the pressing member comprises a porous material, and wherein, in the heating step, the organic resin generates a gas through thermal decomposition, and the gas is released through the pressing member.

8. A method for manufacturing a display in which an electron-emitting substrate including a plurality of electron-emitting devices thereon to project electrons is placed to face a light emitting substrate including a phosphor film and the electron-emitting substrate is bonded together with the light emitting substrate, the method comprising the step of:
manufacturing the light emitting substrate including the phosphor film by the manufacturing method according to claim 5.
